(19) United States
(12) Patent Application Publication
(10) Pub. No.: US 2026/0256303 A1
(43) Pub. Date: Sep. 3, 2026

(54) Tool Holders for a Vertical Support

(71) Applicant: 1046959 Ontario Inc., Burlington (CA)

(72) Inventor: Marco Sixtus Ferrari, Hamilton (CA)

(21) Appl. No.: 19/068,034

(22) Filed: Mar. 3, 2025

(51) Int. Cl. A47F 5/08; B25H 3/00

(52) U.S. Cl. CPC A47F 5/0823; B25H 3/00

(57) ABSTRACT

The present invention relates to a tool holder for use on a support with support holes, said tool holder including a base with at least two pins on one side of the base which pins fit in the support holes, an arm extending from the other side of the base, and a tool holder means at the end of the arm, which tool holder means is a hook or a clip.

### BACKGROUND OF THE INVENTION

### Field of the Invention

The present invention relates to tool holders, and more specifically to tool holders for holding tools on a vertical support.

### Description of Related Art

Toolboxes, tool belts, and pegboards with wall hooks are used for holding tools. With such holders, the tools are not scattered about and can be located when needed. Tools stored on walls or other vertical surfaces are more easily accessed as well as saving space by not being in storage containers.

Tools may be hung on a pegboard, which is a board perforated with holes, for ease of selecting the correct tool and to avoid having to open a toolbox. Pegboards are usually hung on a wall but may also be laid flat on a table or in a drawer in a tool chest. Hooks or other tool holders are inserted at one end to the holes in the pegboard and hold a tool at the other end, for example, curved wires that on one end hook into holes in a pegboard and on the other end are inserted into a hole in a tool to hang the tool.

In United States Patent No. 10,618,159, a tool chest organization board with a plurality of holes is described which has holders for holding tools horizontally in a tool chest. This provides an example of a support with support holes that is horizontal.

What is needed are tool holders that connect securely to a vertical support and securely hold various tools.

### SUMMARY OF THE INVENTION

In an embodiment of the present invention there is a tool holder for use on a support with support holes, said tool holder comprising a base with at least two pins on one side of the base which pins fit in the support holes, an arm extending from the other side of the base, and a tool holder means at the end of the arm.

The tool holder means may be a hook. The at least two pins in the tool holder may be three pins. The tool holder may additionally comprise a base hole in the base below the hook. The tool holder may additionally comprise a recess in the base between the pins and above the base hole. The tool holder may additionally comprise a pair of hook ribs under the hook to strengthen the hook. The tool holder may additionally comprise a semicircular hole topper over the hole. The tool holder may additionally comprise a pocket for a label in the hook.

The tool holder means may be a clip. The tool holder may additionally comprise a base hole in the base below the clip. The tool holder may additionally comprise a recess in the base between the pins and above the base hole. The tool holder may additionally comprise a recess in the base below the base hole below the clip. The tool holder may additionally comprise a pair of arm ribs to strengthen the arm. The tool holder may additionally comprise one or more pockets for a label on the base. In a further embodiment, the arm of the tool holder is a hollow double walled arm.

In a further embodiment of the present invention, one or more of the above tool holders are used on a support with support holes to hold tools.

In a further embodiment of the invention, the support is attached to or comprises a wall or a side of a toolbox.

### BRIEF DESCRIPTION OF THE DRAWINGS

The terms Fig., Figs., Figure, and Figures are used interchangeably in the specification to refer to the corresponding figures in the drawings.

These and other aspects of the present invention will be apparent from the brief description of the drawings and the following detailed description in which:

FIG. 1a is a front view of a first embodiment of a tool holder with a hook of the present invention.

FIG. 1b is a right-side view of the tool holder of FIG. 1a.

FIG. 1c is a top view of the tool holder of FIG. 1a.

FIG. 1d is a front left-side perspective view of the tool holder of FIG. 1a.

FIG. 1e is a back left-side perspective view of the tool holder of FIG. 1a.

FIG. 1f is a bottom right-side perspective view of the tool holder of FIG. 1a.

FIG. 2a is a front view of a second embodiment of a tool holder with a hook of the present invention.

FIG. 2b is a right-side view of the tool holder of FIG. 2a.

FIG. 2c is a top view of the tool holder of FIG. 2a.

FIG. 2d is a front left-side perspective view of the tool holder of FIG. 2a.

FIG. 2e is a back left-side perspective view of the tool holder of FIG. 2a.

FIG. 2f is a bottom right-side perspective view of the tool holder of FIG. 2a.

FIG. 3a is a front view of a first embodiment of a tool holder with a clip of the present invention.

FIG. 3b is a right-side view of the tool holder of FIG. 3a.

FIG. 3c is a top view of the tool holder of FIG. 3a.

FIG. 3d is a front left-side perspective view of the tool holder of FIG. 3a.

FIG. 3e is a back left-side perspective view of the tool holder of FIG. 3a.

FIG. 4a is a front view of a second embodiment of a tool holder with a clip of the present invention.

FIG. 4b is a right-side view of the tool holder of FIG. 4a.

FIG. 4c is a top view of the tool holder of FIG. 4a.

FIG. 4d is a front left-side perspective view of the tool holder of FIG. 4a.

FIG. 4e is a back left-side perspective view of the tool holder of FIG. 4a.

FIG. 5a is a front view of a third embodiment of a tool holder with a clip of the present invention.

FIG. 5b is a right-side view of the tool holder of FIG. 5a.

FIG. 5c is a top view of the tool holder of FIG. 5a.

FIG. 5d is a front left-side perspective view of the tool holder of FIG. 5a.

FIG. 5e is a back left-side perspective view of the tool holder of FIG. 5a.

FIG. 6a is a top view of a tool holder with a clip with a tool in a first position.

FIG. 6b is the tool holder of FIG. 6a with the tool in a second position.

FIG. 6c is the tool holder of FIG. 6a with the tool in a third position.

FIG. 6d is the tool holder of FIG. 6a with the tool in a fourth position.

FIG. 6e is the tool holder of FIG. 6a with the tool in a fifth position.

FIG. 7a is a front left-side perspective view of the tool holder of FIG. 3a with a tool.

FIG. 7b is a front left-side perspective view of two of the tool holders of FIG. 4a with a tool.

FIG. 7c is a front left-side perspective view of the tool holder of FIG. 5a with a tool.

FIG. 8 is a front left-side perspective view of two of the tool holders of FIG. 1a on a vertical support with a tool.

FIG. 9 is a front right-side perspective view of two of the tool holders of FIG. 2a with a tool.

FIG. 10 is a front right-side perspective view of two of the tool holders of FIG. 3a with a tool and two of the tool holders of FIG. 1a with the same tool.

### DESCRIPTION OF THE INVENTION

In an embodiment of the present invention there is a tool holder 100, 200, 300, 400, 500 with pins 140, 240, 340, 440, 540 at a first end for inserting into support holes 710 in a support 700, and with tool holder means at a second end comprising either a hook 130, 230 or a clip 330, 430, 530. The support 700 may be attached to or comprise a wall or outer side of a toolbox or inner back wall of a toolbox etc. The tools may be screwdrivers, wrenches, power tools etc.

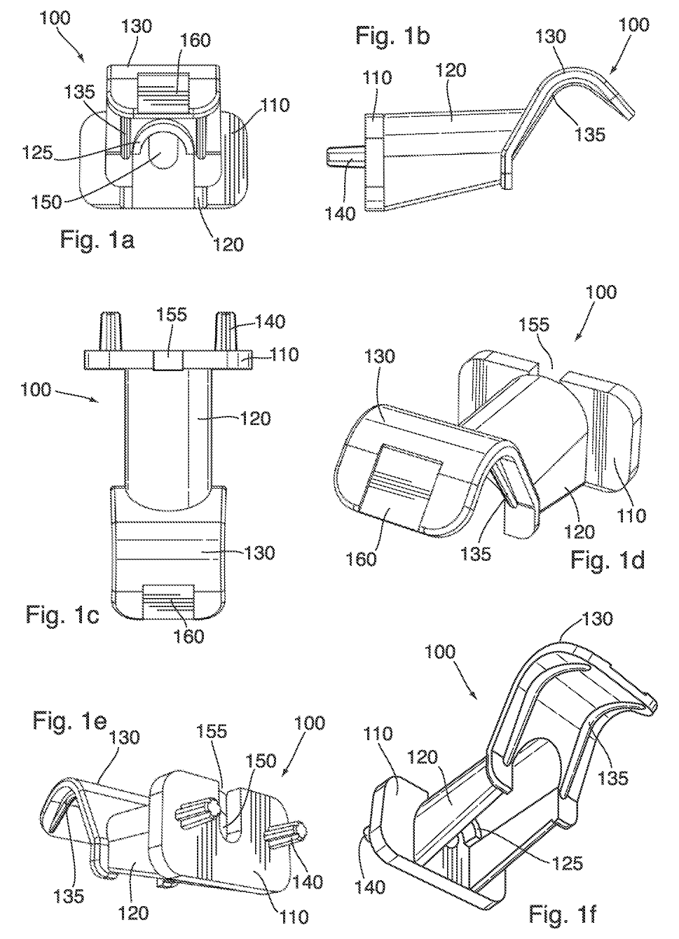

In FIGS. 1a to 1f, a first embodiment of the present invention of a first tool holder 100 with a first hook 130 is shown. The first tool holder 100 at a first end comprises a first base 110 from which back extends two first pins 140. The first base 110 comprises a first base hole 150 under the first hook 130 with an optional semicircular first hole topper 125 for structural support and an optional first recess 155 at the back of the first base 110 for ease of manufacturing with the first base hole 150. From the front of the first base 110 extends a first arm 120 ending in the first hook 130 with two optional first hook ribs 135 for structural support and optional first label pocket 160 for adding a tool identification label to the first hook 130.

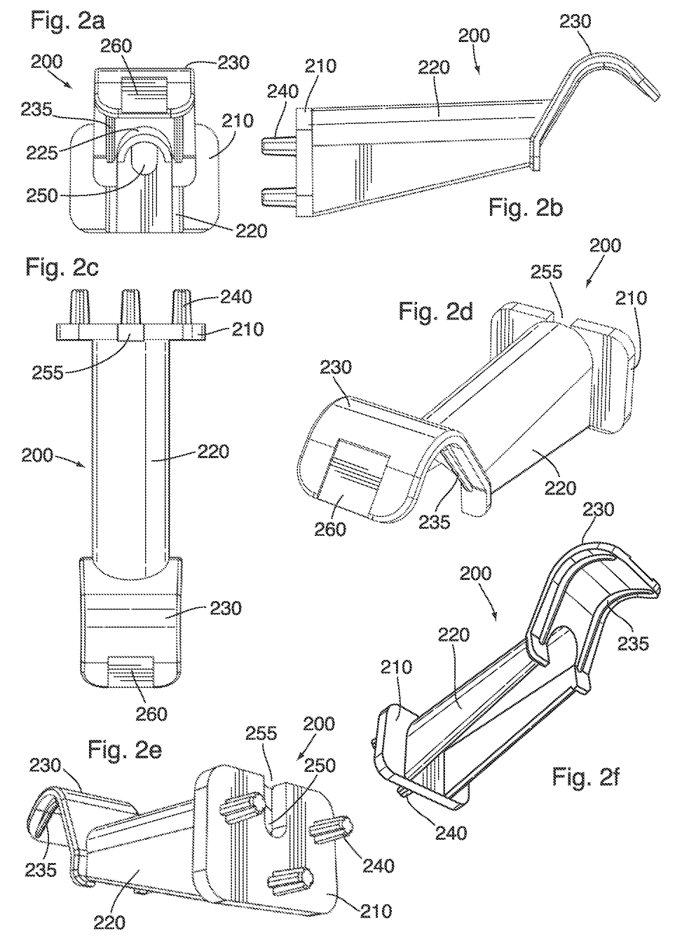

In FIGS. 2a to 2f, a second embodiment of the present invention of a second tool holder 200 with a second hook 230 is shown. The second tool holder 200 is larger but has the same configuration as the first tool holder 100 except for a longer second arm 220 and an optional additional second pin 240. Accordingly, the second tool holder 200 at a first end comprises a second base 210 from which back extends three second pins 140. The second base 210 comprises a second base hole 250 under the second hook 230 with an optional semicircular second hole topper 225 for structural support and an optional second recess 255 at the back of the second base 210 for ease of manufacturing with the second base hole 250. From the front of the second base 210 extends the second arm 220 ending in the second hook 230 with two optional second hook ribs 235 for structural support and optional second label pocket 260 for adding a tool identification label to the second hook 230.

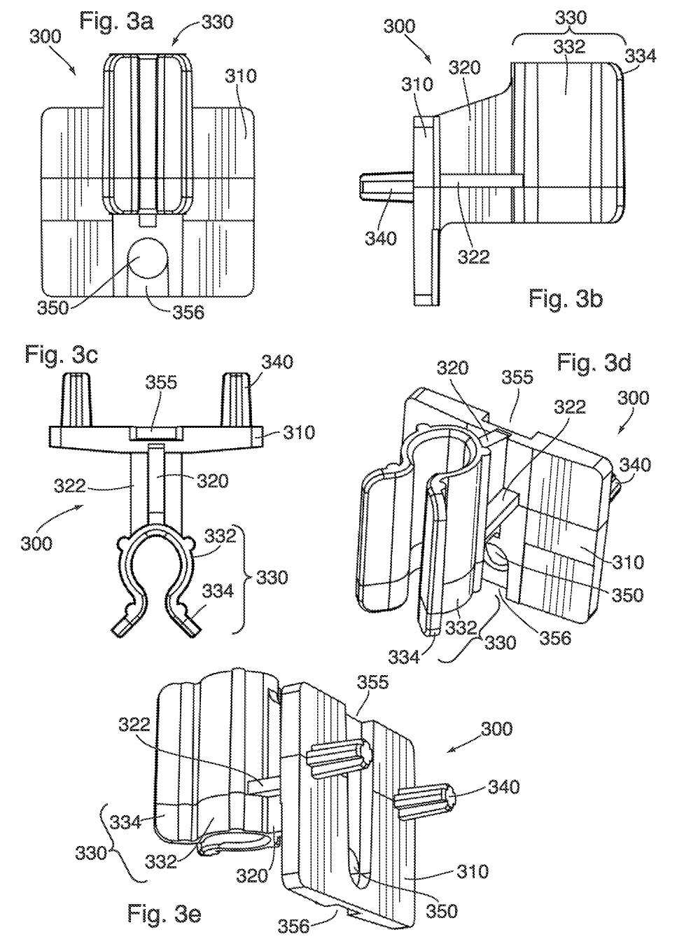

In FIGS. 3a to 3e, a third embodiment of the present invention of a third tool holder 300 with a third clip 330 is shown. The third clip 330 comprises a third clip body 332 which is round with an open end at which two third clip arms 334 curve outwardly. The third tool holder 300 at a first end comprises a third base 310 from which back extends two third pins 340. The third base 310 comprises a third base hole 350 under the third clip 330 with an optional third back recess 355 at the back of the third base 310 and an optional third front recess 356 at the front of the third base 310, both for ease of manufacturing the tool holder with the third base hole 350. From the front of the third base 310 extends a third arm 320, with two optional third arm ribs 322 for structural support, ending in the third clip 330. The third base 310 may additionally comprise a pocket on one or both sides of the third base hole 350 below the third clip 330 for adding an optional label for identification.

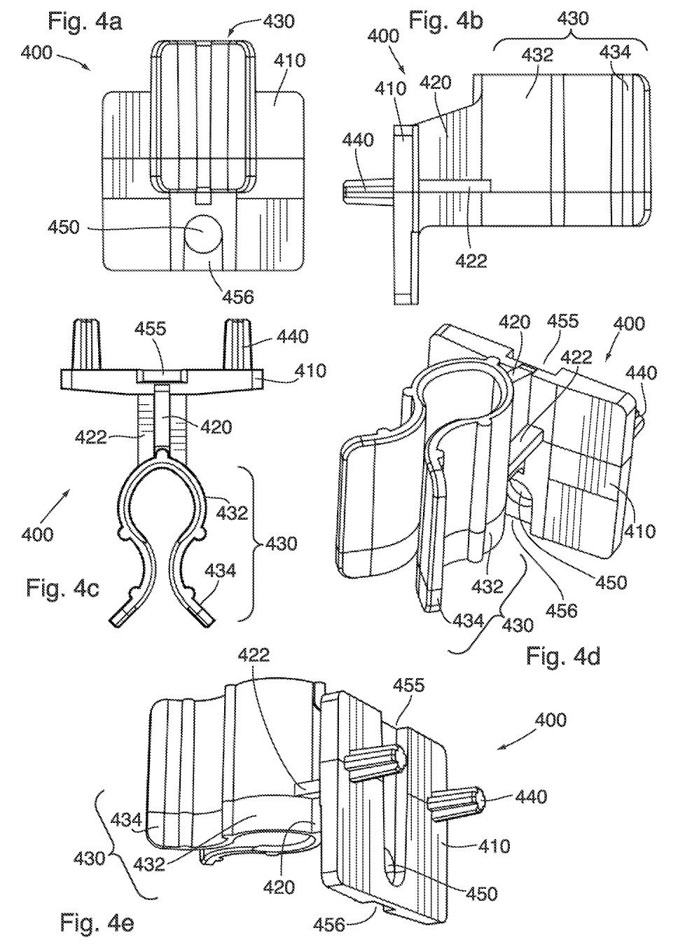

In FIGS. 4a to 4e, a fourth embodiment of the present invention of a fourth tool holder 400 with a fourth clip 430 is shown. The fourth tool holder 400 is larger but has the same configuration as the third tool holder 300. Accordingly, the fourth clip 430 comprises a fourth clip body 432 which is round with an open end at which two fourth clip arms 434 curve outwardly. The fourth tool holder 400 at a first end comprises a fourth base 410 from which back extends two fourth pins 440. The fourth base 410 comprises a fourth base hole 450 under the fourth clip 430 with an optional fourth back recess 455 at the back of the fourth base 410 and an optional fourth front recess 456 at the front of the fourth base 410, both for ease of manufacturing the tool holder with the fourth base hole 450. From the front of the fourth base 410 extends a fourth arm 420, with two optional fourth arm ribs 422 for structural support, ending in the fourth clip 430. The fourth base 410 may additionally comprise a pocket on one or both sides of the fourth base hole 450 below the fourth clip 430 for adding an optional label for identification.

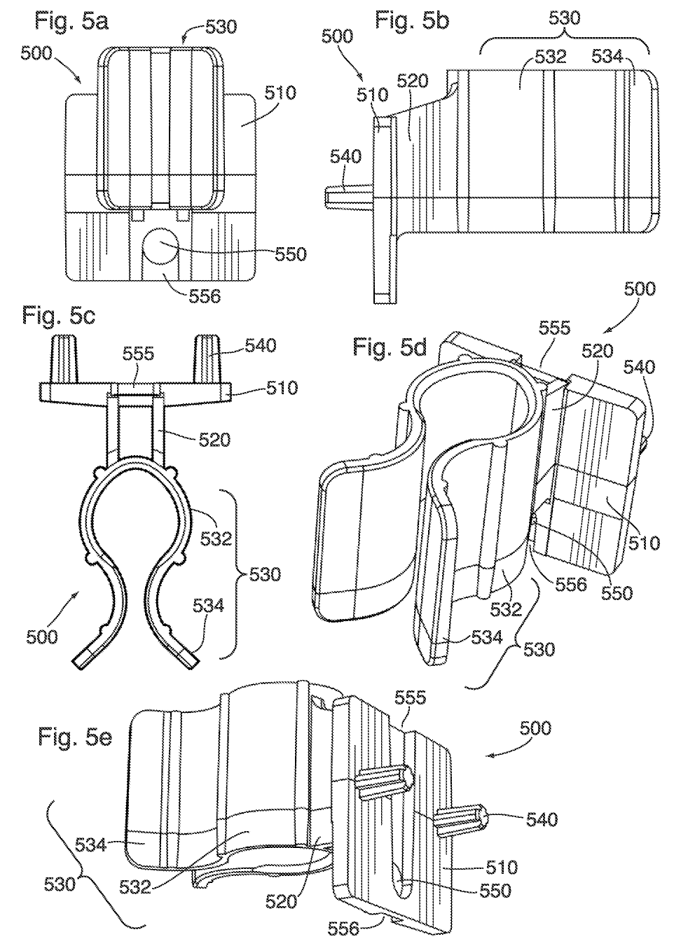

In FIGS. 5a to 5e, a fifth embodiment of the present invention of a fifth tool holder 500 with a fifth clip 530 is shown. The fifth tool holder 500 is larger but has the same configuration as the fourth tool holder 400 except that a fifth arm 520 comprises a double wall which is hollow (but may be filled in) and there are no optional fourth arm ribs 422 (although it will be understood that the fourth arm 420 and optional fourth arm ribs 422 could be enlarged/strengthened as an alternative). Accordingly, the fifth clip 530 comprises a fifth clip body 532 which is round with an open end at which two fifth clip arms 534 curve outwardly. The fifth tool holder 500 at a first end comprises a fifth base 510 from which back extends two fifth pins 540. The fifth base 510 comprises a fifth base hole 550 under the fifth clip 530 with an optional fifth back recess 555 at the back of the fifth base 510 and an optional fifth front recess 556 at the front of the fifth base 510, both for ease of manufacturing the fifth tool holder with the fifth base hole 550. From the front of the fifth base 510 extends the fifth arm 520 ending in the fifth clip 530. The fifth base 510 may additionally comprise a pocket on one or both sides of the fifth base hole 550 below the fifth clip 530 for adding an optional label for identification.

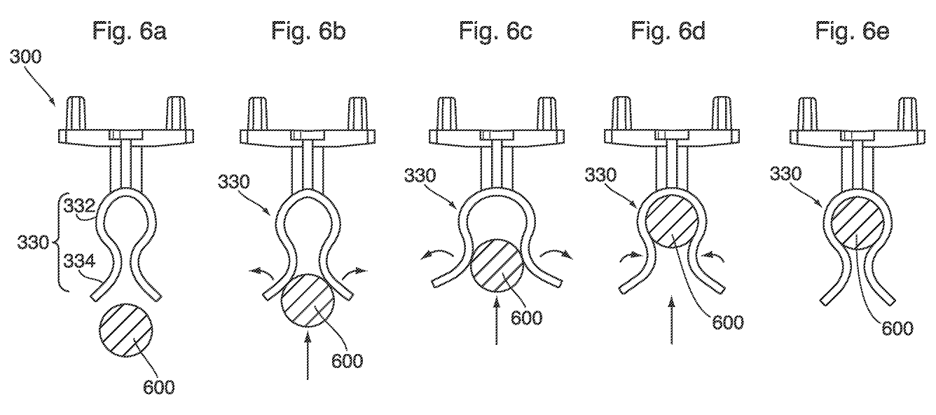

FIGS. 6a to 6e show the third tool holder 300 with the third clip 330 engaging with a first tool 600. It will be understood that the first tool 600 is pushed into the third clip 330 and then holds the first tool 600 in a fluid motion and that the positions shown in FIGS. 6a to 6e are for explanatory purposes as follows. Firstly, FIG. 6a shows that the third tool holder 300 is a suitable size for the first tool 600 in a first position. The first tool 600 in a second position is inserted between the third clip arms 334 which start to bend outwardly as shown in FIGS. 6b and then bend further out as the first tool 600 in a third position is inserted farther as shown in FIG. 6c until the first tool 600 in fourth position pops into the third clip body as shown in FIG. 6d which allows the third clip arms 334 to bounce back into place and the first tool 600 in fifth position is held securely by the third clip body 332 as shown in FIG. 6e. If the first tool 600 is removed, the third clip 330 will look like FIG. 6a again.

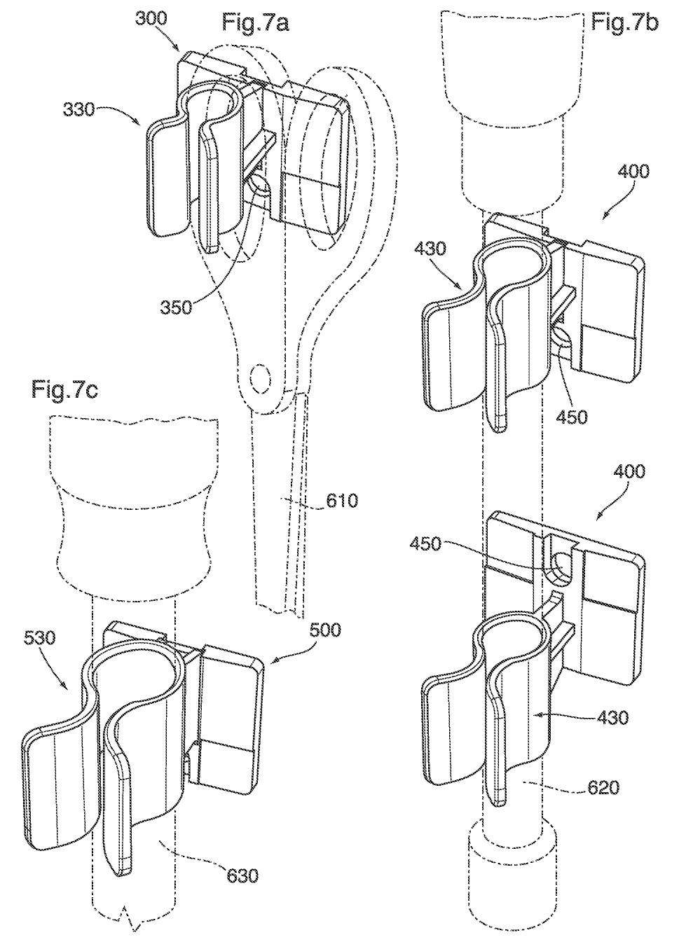

FIGS. 7a to 7c show how different size tool holders 300, 400 and 500 can hold different tools. In FIG. 7a, a handle of a scissors 610 can be held by a third clip 330 of a third tool holder 300. In FIG. 7b, a first nut driver 620 can be held by the fourth clips 430 of two fourth tool holders 400. In FIG. 7c, a second nut driver 630 can be held by the fifth clip 530 of a fifth tool holder 500.

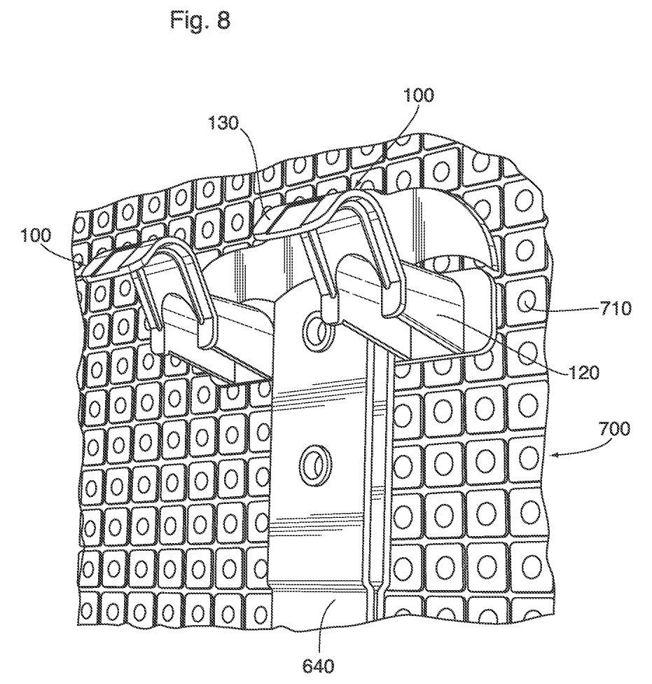

FIGS. 8 to 10 show how tool holders of the present invention may be configured on a support 700 to hold various tools, and it will be understood that there are a wide variety of combinations of tool holders configured to hold various tools.

FIG. 8 shows two first tool holders 100 on a support 700 with first hooks 130 oriented in an upward position so that the top of a T-shaped tool 640 rests on the first arms 120.

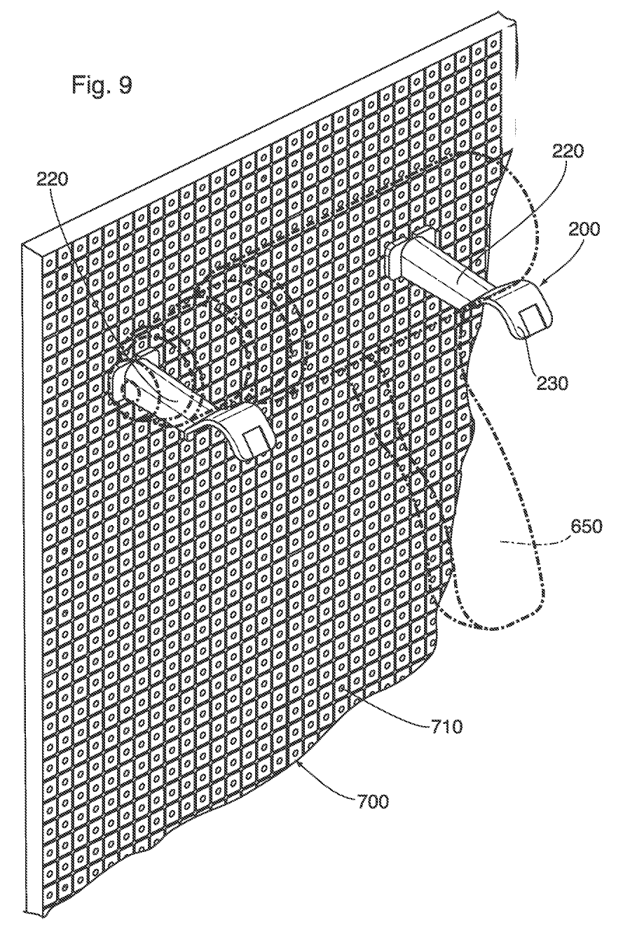

FIG. 9 shows an electric drill 650 being held on the second arms 220 of second tool holders 200 with second hooks 230 oriented in a downwards position. The second pins 240 (not shown) are inserted in support holes 710 and screws (not shown) secure the second tool holders 200 to the support 700.

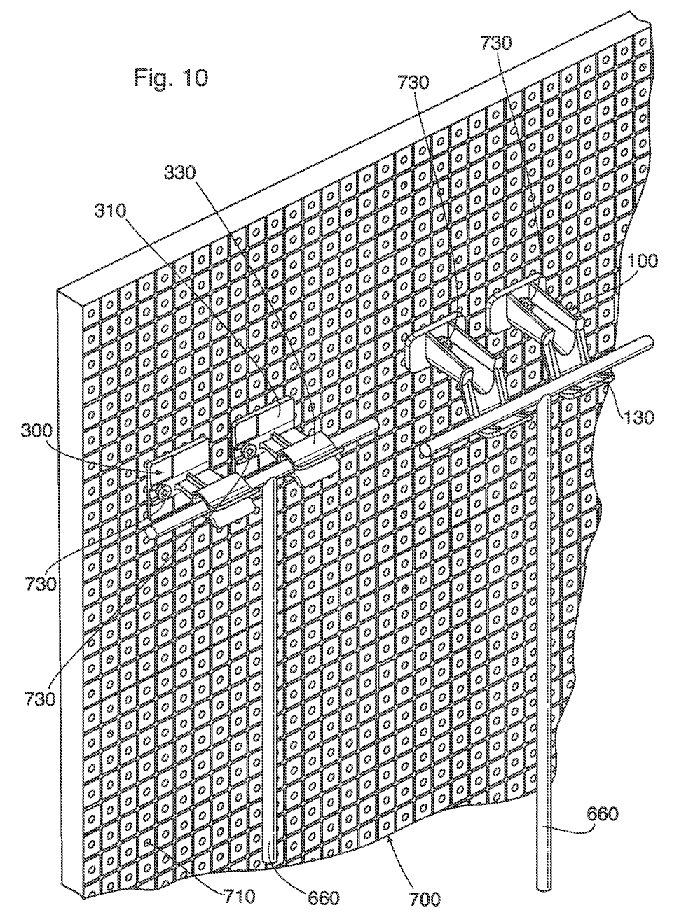

FIG. 10 shows how a T-handle wrench 660 may be held by the third clips 330 of two tool holders 300 oriented sideways and secured with screws 730 through the third base holes 350 into support holes 710. Alternatively, the T-handle wrench 660 may be held by the first hooks 130 oriented upward of two first tool holders 100 secured by screws 730 through the first base hole 150 into support holes 710.

To use any of the tool holders 100, 200, 300, 400, 500 of the present invention, the desired location on a support 700 for a tool holder 100 is chosen and first pins 140 are inserted into the support holes 710 to hold the tool holder 100 in place for fastening it to the support 700. Then screws 730 are inserted through the first base hole 150 and into the support hole 710. Attaching screws to the support 700, through the tool holders 100, locks it in place. The tool holders 100, 200, 300, 400, 500 can be unscrewed from the support 700 and reused in a different location on the support 700 and with different tools in different configurations.

The tool holders 100, 200, 300, 400, 500 can be made of a durable plastic or other material that is durable, mouldable, and especially for the clip portions is springy or flexible. For example, Polyoxymethylene (POM) or Polyacetal Plastic or from other plastics such as, Polypropylene (PP) or nylon.

It is understood that the tool holder 100, 200, 300, 400, 500 can be prefabricated to hold standard size tools, or may be custom-made to hold odd-sized or unique tools.

The two (or three) pins on the tool holders are spaced to line up with two (or three) support holes on a support for insertion of all the pins into the corresponding support holes, and when the pins are inserted into support holes, then the base hole is also lined up with a support hole for insertion of a screw.

In the embodiment of the present invention of a tool holder 100, 200, 300, 400, 500 shown in the figures the base hole 150, 250, 350, 450, 550 is sized to permit a screw to pass through the tool holder and into the support hole 710 in the support 700 to fasten the tool holder in place. It will be understood that there are alternatives to the base holes shown in the figures, such as a slit to fit the tip of a screw through, or a thinner material where the hole is shown that permits puncturing by a screw.

The support 700 may be made of plastics or wood or other material that can be perforated with holes but maintain its rigidity and shape. It will be understood that the tool holders could attach to a support that is oriented in a non-vertical orientation, but the vertical orientation permits easy access to tools on a wall and space saving. For example, the support 700 may be 0.375” thick polypropylene plastic with support holes 710 measuring 0.375” centerline to centerline, and 0.315” deep or all the way through the board. The support holes 710 may have a diameter of 0.14” at the top and taper to 0.12” at the bottom. The screws used 730 may be slightly larger in diameter than the support holes 710 to bite and thread into the plastic. The screws 730 may be ordinary, available self-threading screws that can tap into the support holes 710 and secure the tool holders in place.

While embodiments of the invention have been described in the detailed description, the scope of the claims should not be limited by the preferred embodiments set forth in the examples but should be given the broadest interpretation consistent with the description as a whole.

What is claimed is:

1. A tool holder for use on a support with support holes, said tool holder comprising a base with at least two pins on one side of the base which pins fit in the support holes, an arm extending from the other side of the base, and a tool holder means at the end of the arm.

2. The tool holder of claim 1, in which the tool holder means is a hook.

3. The tool holder of claim 2, in which the at least two pins are three pins.

4. The tool holder of claim 2, additionally comprising a base hole in the base below the hook.

5. The tool holder of claim 4, additionally comprising a recess in the base between the pins and above the base hole.

6. The tool holder of claim 5, additionally comprising a pair of hook ribs under the hook to strengthen the hook.

7. The tool holder of claim 6, additionally comprising a semicircular hole topper over the hole.

8. The tool holder of claim 7, additionally comprising a pocket for a label in the hook.

9. The tool holder of claim 7, in which the at least two pins are three pins.

10. The tool holder of claim 1, in which the tool holder means is a clip.

11. The tool holder of claim 10, additionally comprising a base hole in the base below the clip.

12. The tool holder of claim 11, additionally comprising a recess in the base between the pins and above the base hole.

13. The tool holder of claim 12, additionally comprising a recess in the base below the base hole below the clip.

14. The tool holder of claim 13, additionally comprising a pair of arm ribs to strengthen the arm.

15. The tool holder of claim 14, additionally comprising one or more pockets for a label on the base.

16. The tool holder of claim 11, in which the arm is a hollow double walled arm.

17. The use of one or more of the tool holder of claim 1, on a support with support holes to hold tools.

18. The tool holder of claim 1, in which the support is attached to or comprises a wall or a side of a toolbox.
